(19) United States
(12) Patent Application Publication
(10) Pub. No.: US 2025/0045041 A1
(43) Pub. Date: Feb. 6, 2025

(54) UPDATE METHOD OF REDUNDANCY SYSTEM, REDUNDANCY SYSTEM, AND UPDATE CONTROL DEVICE

(71) Applicant: Nippon Telegraph and Telephone Corporation, Tokyo (JP)

(72) Inventors: Kenta Shinohara, Musashino-shi, Tokyo (JP); Susumu NAKAZAWA, Musashino-shi, Tokyo (JP); Fumihiko SAWAZAKI, Musashino-shi, Tokyo (JP); Yuki AKAMATSU, Musashino-shi, Tokyo (JP)

(21) Appl. No.: 18/718,227

(22) PCT Filed: Dec. 14, 2021
(86) PCT No.: PCT/JP2021/045939

§ 371 Date: Jun. 10, 2024

(51) Int. Cl. G06F 8/656; G06F 9/455; G06F 11/14

(52) U.S. Cl. CPC G06F 8/656; G06F 9/455; G06F 11/14; G06F 2009/45595

(57) ABSTRACT

An update control device (100) of a redundancy system (300) updates an application installed in a virtual machine (211, 212) included in each of a stack (201) and a stack (202) each indicating an instance group of a virtual resource. An update control device (100) executes a creation step of generating a virtual machine (215, 216) corresponding to each stack (201, 202) and including a stack (205, 206) in which a new application is stored, and a changing step of sequentially performing a process of changing a stack indicating the secondary interface associated with each stack (205, 206) to each stack (203, 204).

### TECHNICAL FIELD

The present invention relates to an update method of a redundancy system, a redundancy system, and an update control device that provision server resources and execute setting/change and the like on a cloud environment.

### BACKGROUND ART

With the spread of cloud services, for example, in order to easily construct, expand, or relocate a virtual resource environment on a cloud, there is known a technique of templating configuration information of virtual resources and performing collective deployment (see, for example, Non Patent Literature 1 and Non Patent Literature 2).

In this technology, an instance group of a virtual resource deployed on the basis of a template is referred to as a stack. The virtual resource generated in the stack can be referred to and used from other stacks and the like, and the construction of the environment of the entire cloud environment can be easily implemented by combining stacks.

### CITATION LIST

### Non Patent Literature

Non Patent Literature 1: “AWS CloudFormation”, [online], [retrieved on Nov. 22, 2021], the Internet <https://aws.amazon.com/jp/cloudformation/?nc1=h_ls>
Non Patent Literature 2: Heat, “OpenStack Orchestration”, [online], [retrieved on Nov. 22, 2021], the Internet <https://wiki.openstack.org/wiki/Heat>

### SUMMARY OF INVENTION

### Technical Problem

In a configuration of a stack in the related art, when executing update of an application on a virtual server, a method of recreating the stack by using a latest template definition is generally used.

However, when executing update of an application on a redundant virtual server in an active standby configuration, in order to update without changing the Internet protocol (IP) address for inter-server communication, it is necessary to delete the stack on one side to temporarily bring the virtual server of the system into a single-system state, and then update the virtual servers one by one.

Here, there are two problems in the procedure of executing this update. The first problem is that the virtual server is in a single-system state during update, and when a failure occurs by any chance, the virtual server may be in a state of not operating in either the active state or the standby state.

Further, the second problem is that, since the operating stack is deleted every time the update process proceeds, the server cluster cannot be returned to the initial state when an unexpected problem occurs during the update.

The present invention has been made in view of such points, and an object thereof is to be able to shorten a time during which a virtual server is in a single-system state at the time of updating an application of the virtual server, improve availability, and return a server cluster to an initial state even when an unexpected problem occurs.

### Solution to Problem

An update control method of a redundancy system according to the present invention is an update control method of a redundancy system including a first stack indicating an instance group of a virtual resource, a second stack indicating an instance group of a virtual resource, and an update control device that controls update of an application stored in each of virtual resources of the first stack and the second stack, in which the first stack constitutes a virtual server in association with a third stack indicating a secondary interface for communication with another stack other than the first stack, and the second stack constitutes a virtual server in association with a fourth stack indicating the secondary interface, the virtual servers are redundant in an active state or a standby state, and the update control device executes a creation step of generating a virtual server corresponding to the first stack and including a fifth stack in which a new application indicating the application that is updated is stored and a virtual server corresponding to the second stack and including a sixth stack in which the new application is stored, and a changing step of sequentially performing a process of changing a stack indicating the secondary interface associated with the fifth stack to the third stack and a process of changing a stack indicating the secondary interface associated with the sixth stack to the fourth stack.

### Advantageous Effects of Invention

According to the present invention, it is possible to shorten a time during which a virtual server is in a single-system state at the time of updating an application of the virtual server, improve availability, and return a server cluster to an initial state even when an unexpected problem occurs.

### BRIEF DESCRIPTION OF DRAWINGS

FIG. 1 is a block diagram illustrating an overall configuration of a redundancy system including an update control device according to the present embodiment.

FIG. 2A is a flowchart illustrating a flow of update control process executed by the update control device of the redundancy system according to the present embodiment (part 1).

FIG. 2B is a flowchart illustrating a flow of update control process executed by the update control device of the redundancy system according to the present embodiment (part 2).

FIG. 3A is a diagram for describing a process in which a stack creation unit creates stacks in a server cluster.

FIG. 3B is a diagram for describing a change process of a network interface executed by a stack setting change unit and a switching process of network interface association executed by a stack update unit.

FIG. 3C is a diagram for describing a process in which a virtual server transitions from a standby state to an active state by stopping an instance of a stack.

FIG. 3D is a diagram for describing a process in which the stack setting change unit changes a setting of a stack and the stack update unit executes an update command on the stacks.

FIG. 3E is a diagram for describing a process of deleting an unnecessary stack by a stack deletion unit.

FIG. 4 is a hardware configuration diagram illustrating an example of a computer that implements functions of the update control device according to the present embodiment.

FIG. 5A is an explanatory diagram in which an ACT/SBY type redundancy system as a comparative example is constructed using conventional stacks.

FIG. 5B is an explanatory diagram illustrating a method of updating an application in the ACT/SBY type redundancy system as a comparative example using the conventional stacks (part 1).

FIG. 5C is an explanatory diagram illustrating a method of updating the application in the ACT/SBY type redundancy system as a comparative example using the conventional stacks (part 2).

FIG. 5D is an explanatory diagram illustrating a method of updating the application in the ACT/SBY type redundancy system as a comparative example using the conventional stacks (part 3).

FIG. 5E is an explanatory diagram illustrating a method of updating the application in the ACT/SBY type redundancy system as a comparative example using the conventional stacks (part 4).

### DESCRIPTION OF EMBODIMENTS

Next, a mode for carrying out the present invention (hereinafter referred to as the “present embodiment”) will be described. First, an outline of the present technology will be described using the related art as a comparative example.

### <Outline of Present Technology>

In the present technology, an instance group of a virtual resource deployed on the basis of a template is referred to as a stack. In a redundancy system including two stacks (two servers), as an example, a method of updating a predetermined application (APL) installed in a virtual machine included in each of the two stacks will be described.

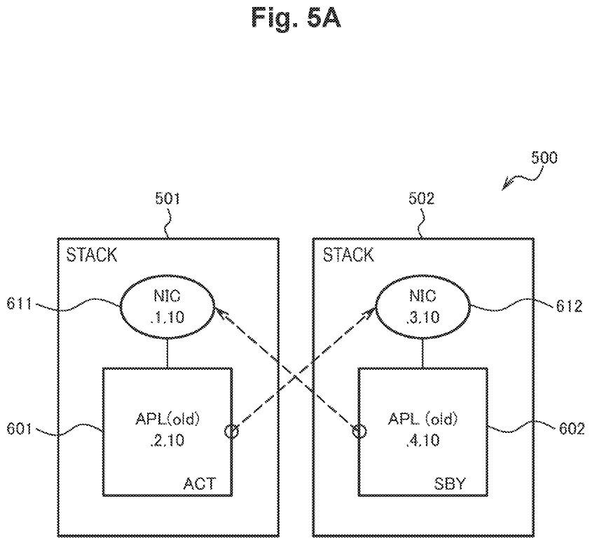

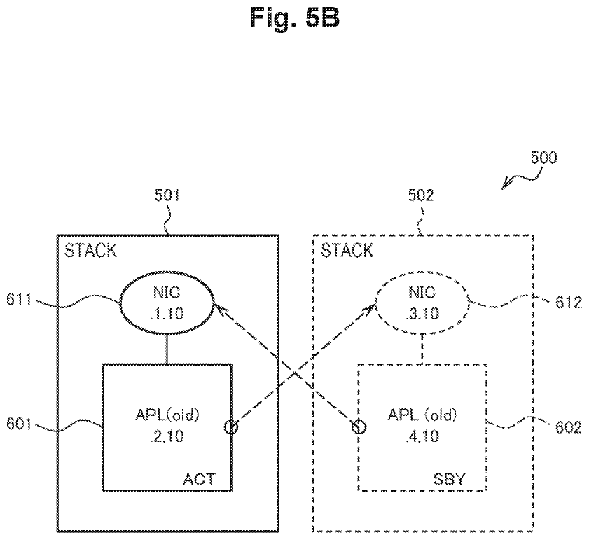

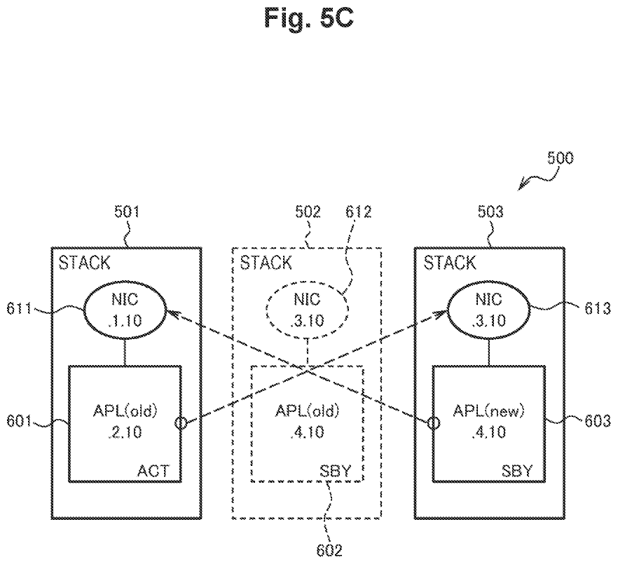

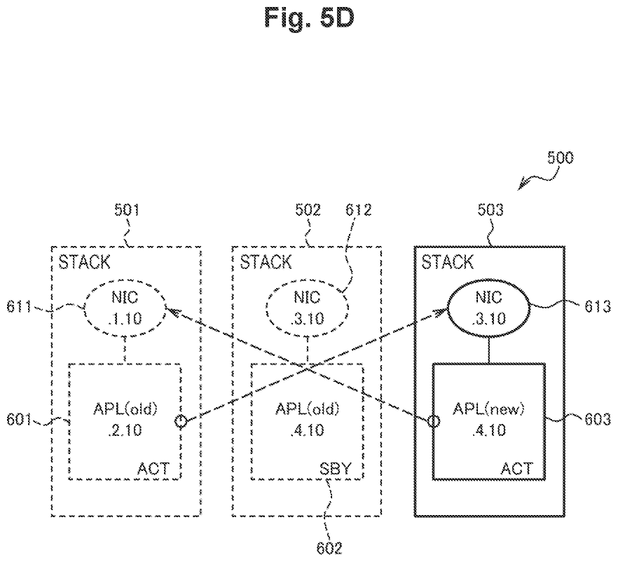

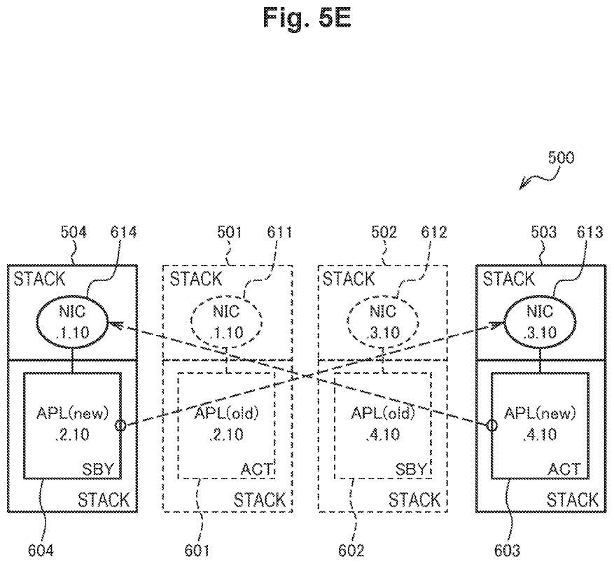

FIG. 5A is an explanatory diagram in which an Active (ACT)/Standby (SBY) type redundancy system 500 is constructed using a stack of the related art as a comparative example. As illustrated in FIG. 5A, the ACT/SBY type redundancy system 500 as a comparative example includes a stack 501 on the left side and a stack 502 on the right side.

The stack 501 creates a predetermined virtual resource by using a predetermined template, and creates one of the servers having an ACT/SBY configuration. Specifically, the stack 501 is created with a predetermined template, one virtual machine 601 is started, and a predetermined application (APL: old) is installed.

The virtual machine 601 includes an interface for maintenance, and has an Internet Protocol (IP) address 10.10.2.10 (hereinafter simply referred to as. 2.10. Note that the same applies to other IP addresses). An NIC 611 indicating a secondary network interface card (NIC) for inter-server communication is attached to the virtual machine 601, and the NIC 611 has an IP address.1.10.

An inter-system monitoring program (keepalived: hereinafter, this is also simply referred to as a monitoring program) of ACT/SBY is set in the virtual machine 601, and is set to execute normality monitoring on the IP address.3.10 of an NIC 612 of a paired virtual machine 602. Note that the virtual machine 601 has transitioned to the ACT (active) state in FIG. 5A.

Further, the stack 502 similarly creates a predetermined virtual resource by using a predetermined template, and creates one of the servers having the ACT/SBY configuration. Specifically, the stack 502 is created with a predetermined template, one virtual machine 602 is started, and a predetermined application (APL: old) is installed.

The virtual machine 602 includes an interface for maintenance and has an IP address.4.10. The secondary NIC 612 for inter-server communication is attached to the virtual machine 602, and the NIC 612 has an IP address.3.10.

The inter-system monitoring program of ACT/SBY is also set in the virtual machine 602, and is set to execute the normality monitoring on the IP address.1.10 of the NIC 611 of the paired virtual machine 601. Note that, in FIG. 5A, the virtual machine 602 transitions to a standby (SBY) state.

In the configuration of the redundancy system 500 having such two stacks 501 and 502, when update of the predetermined application (APL: old) of the virtual machines 601 and 602 is executed, a method of recreating a new stack using a latest template definition is conventionally generally used.

For example, when executing update of the predetermined application (APL: old) of the virtual machines 601 and 602, in order to execute the update without changing IP addresses for communication between the virtual machines 601 and 602, first, the stack on one side of the stacks 501 and 502 constituting the redundancy system 500 is deleted. Then, in the redundancy system 500, the stacks 501 and 502 are temporarily set to a single-system state, and the predetermined application (APL: old) of the virtual machines 601 and 602 is updated one by one. Hereinafter, a method of updating the predetermined application (APL: old) of the virtual machines 601 and 602 from the state of FIG. 5A will be described.

FIG. 5B illustrates a state in which the stack 502 is deleted from the state of FIG. 5A. As illustrated in FIG. 5B, first, in the redundancy system 500, the stack 502 in a standby state constituting one of the servers is deleted.

Next, as illustrated in FIG. 5C, a stack 503 in which the predetermined application (APL: old) of the virtual machine 602 included in the stack 502 is updated is added to the redundancy system 500.

The stack 503 is created from a latest template corresponding to the stack 503. The stack 503 starts a virtual machine 603 and a predetermined new application (APL: new) is installed. Then, the virtual machine 603 transitions to a standby state.

A secondary NIC 613 is attached to the virtual machine 603, and the NIC 613 has an IP address.3.10. The virtual machine 603 monitors the virtual machine 601 with respect to the IP address.1.10 of the NIC 611 of the virtual machine 601. In other words, the virtual machine 603 monitors the virtual machine 601 via the network interface of the virtual machine 601.

FIG. 5D illustrates a state in which the stack 501 is deleted from the state of FIG. 5C. As illustrated in FIG. 5D, when the virtual machine 601 in an active state is deleted, the virtual machine 603 transitions from the standby state to an active state.

As illustrated in FIG. 5E, a stack 504 in which the predetermined application (APL: old) of the virtual machine 601 included in the stack 501 is updated is added to the redundancy system 500.

The stack 504 is created from a latest template corresponding to the stack 504. The stack 504 starts a virtual machine 604 and a predetermined new application (APL: new) is installed. Then, the virtual machine 604 transitions to a standby state.

A secondary NIC 614 is attached to the virtual machine 604, and the NIC 614 has an IP address.1.10. The virtual machine 604 monitors the virtual machine 603 with respect to the IP address.3.10 of the NIC 613 of the virtual machine 603. In other words, the virtual machine 604 monitors the virtual machine 603 via the network interface of the virtual machine 603.

As described above, the predetermined application (APL: old) of the virtual machines 601 and 602 is conventionally updated to the predetermined application (APL: new) of the virtual machines 603 and 604 by the method illustrated in FIGS. 5A to 5E.

However, this method has two problems. The first problem is that the virtual machine (virtual server) is in a single-system state while the predetermined application (APL: old) of the virtual machines 601 and 602 is updated. Therefore, when a failure occurs in the redundancy system 500, there is a possibility that a state in which the virtual machine (virtual server) is neither in the active state nor in the standby state occurs.

The second problem is that, in the method of the comparative example, a stack including the predetermined application (APL: old) to be updated is deleted in advance, a stack is created again from the latest template, and then the predetermined application (APL: new) is installed. Thus, for example, when a stack is recreated from the latest template, if any problem occurs, since the virtual machine (virtual server) to be updated has already been deleted, it is not possible to return to the original state, that is, the redundancy system 500 (server cluster) to the initial state.

On the other hand, an update method of the redundancy system according to the present embodiment can shorten the time during which the virtual machine (virtual server) is in the single-system state at the time of updating the application of the virtual machine (virtual server), improve availability, and return the redundancy system (server cluster) to the initial state even when an unexpected problem occurs.

### <Redundancy System>

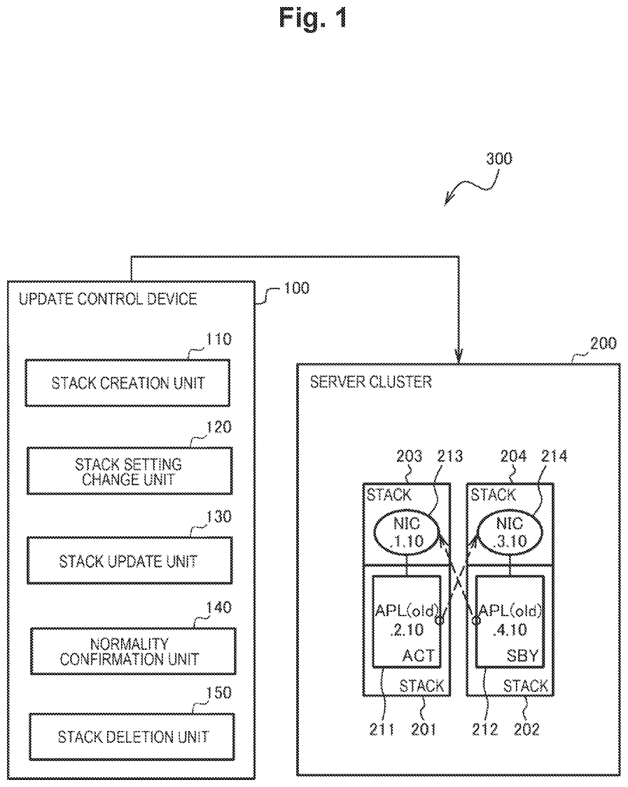

FIG. 1 is a block diagram illustrating an overall configuration of a redundancy system 300 including an update control device 100 according to the present embodiment. Note that FIG. 1 illustrates a configuration during operation (initial state) before update.

As illustrated in FIG. 1, the redundancy system 300 includes an update control device 100 and a server cluster 200.

The redundancy system 300 is a cloud computing system that updates the predetermined application (APL: old) installed in virtual machines 211 and 212 of stacks 201 and 202 accommodated in the server cluster 200.

The server cluster 200 accommodates the stacks 201 to 204. In the server cluster 200, the stacks 201 (first stack) and 203 (third stack) and the stacks 202 (second stack) and 204 (fourth stack) constitute an ACT (active)/SBY (standby) type redundancy system.

The stack 201 and the stack 203 constitute, for example, a virtual server in an active state, and the stack 202 and the stack 204 constitute a virtual server in a standby state. The stack 201 includes the virtual machine 211, and the virtual machine 211 has an IP address.2.10. Further, the stack 202 includes the virtual machine 212, and the virtual machine 212 has an IP address.4.10.

In the virtual machines 211 and 212, the predetermined application (APL: old) to be updated is installed.

In the stack 201, an NIC 213 of the stack 203 is attached as a secondary network interface for inter-server communication with the stack 202 and the like, and the NIC 213 has an IP address.1.10. Further, an NIC 214 of the stack 202 is attached to the stack 201 as a secondary network interface for inter-server communication with the stack 204 and the like, and the NIC 214 has an IP address.3.10.

In the present embodiment, the stacks 203 and 204 are configured separately from the stacks 201 and 202 as separate stacks. Further, the stack 201 monitors the stack 202 via the stack 204, and the stack 202 monitors the stack 201 via the stack 203.

When the virtual machine 211 of the stack 201 is configured, the stack 203 is referred to, and the stack 201 is created by a template for generating the virtual machine 211 using the NIC 213 of the stack 203 as a secondary interface. Further, when the virtual machine 212 of the stack 202 is configured, the stack 204 is referred to, and the stack 202 is created by a template for generating the virtual machine 212 using the NIC 214 of the stack 204 as a secondary interface.

Each of the stacks 201 to 204 creates a predetermined virtual resource by using a predetermined template. Note that the method of creating each stack is not limited to this, and for example, a template may be commonized according to the type of stack, a stack may be created from the commonized template, and each stack may be created so that parameters are different.

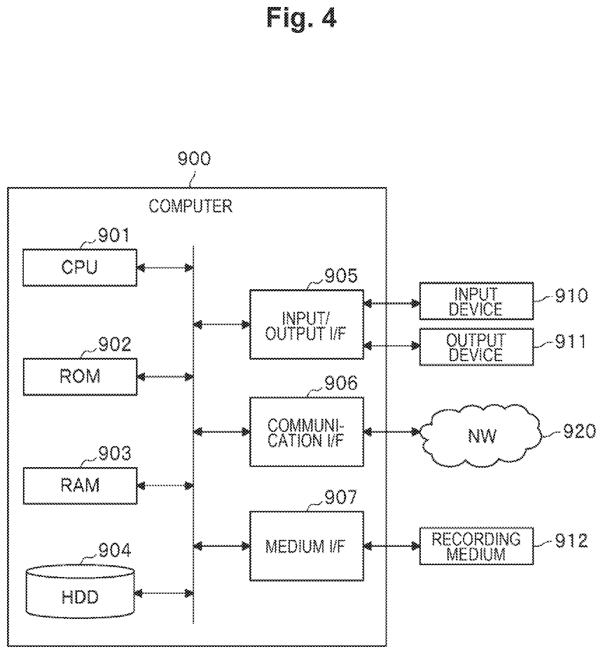

The update control device 100 is a device constituting cloud computing, and is implemented by a computer (see FIG. 4) to be described later.

The update control device 100 updates the predetermined application (APL: old) installed in the virtual machines 211 and 212 of the stacks 201 and 202 accommodated in the server cluster 200. The update control device 100 includes a stack creation unit 110, a stack setting change unit 120, a stack update unit 130, a normality confirmation unit 140, and a stack deletion unit 150.

Here, the stack creation unit 110, the stack setting change unit 120, the stack update unit 130, and the normality confirmation unit 140 are related to each other and execute in cooperation with each other. Thus, functions executed by the stack creation unit 110, the stack setting change unit 120, the stack update unit 130, and the normality confirmation unit 140 are not limited to the following processing. That is, the functions executed by the stack creation unit 110, the stack setting change unit 120, the stack update unit 130, and the normality confirmation unit 140 may be implemented by other components.

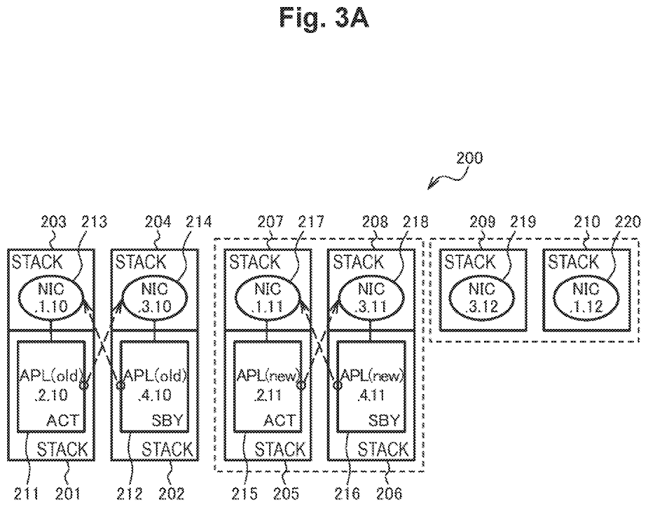

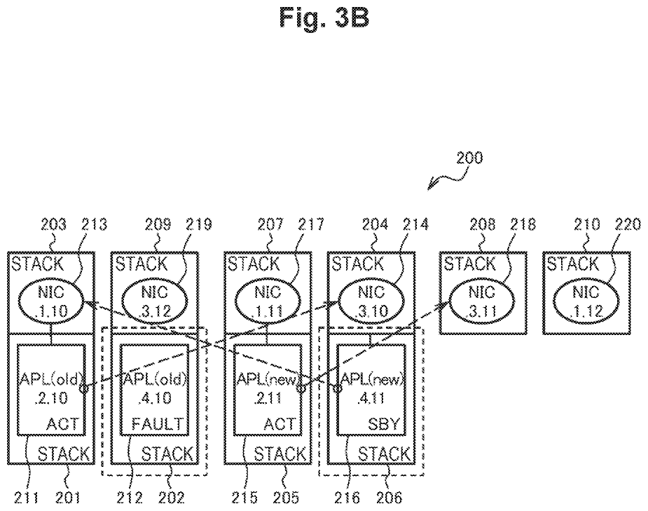

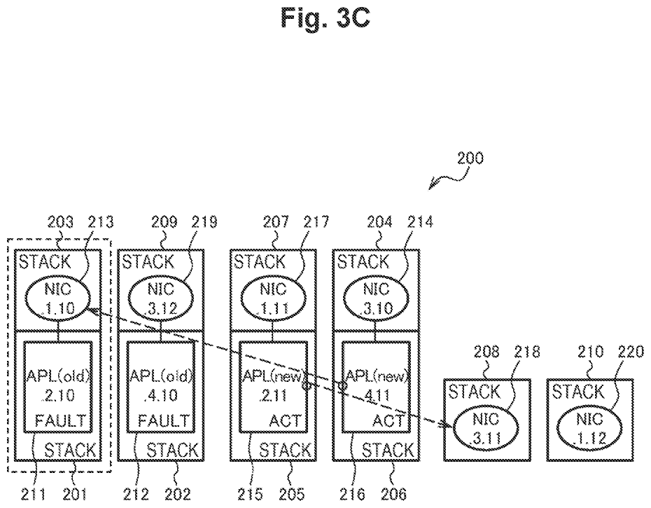

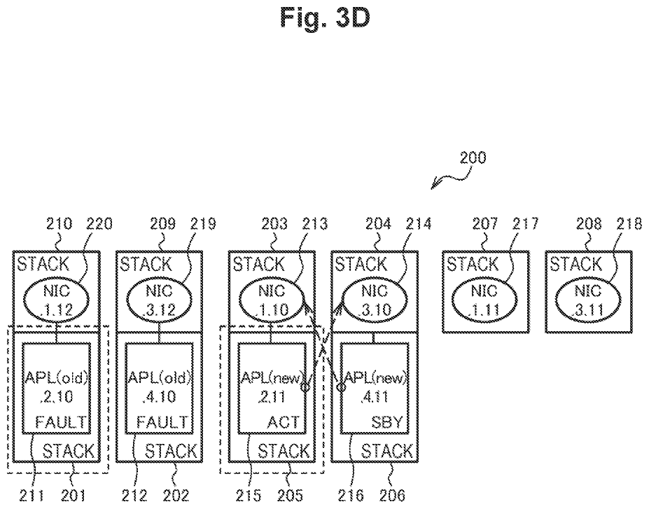

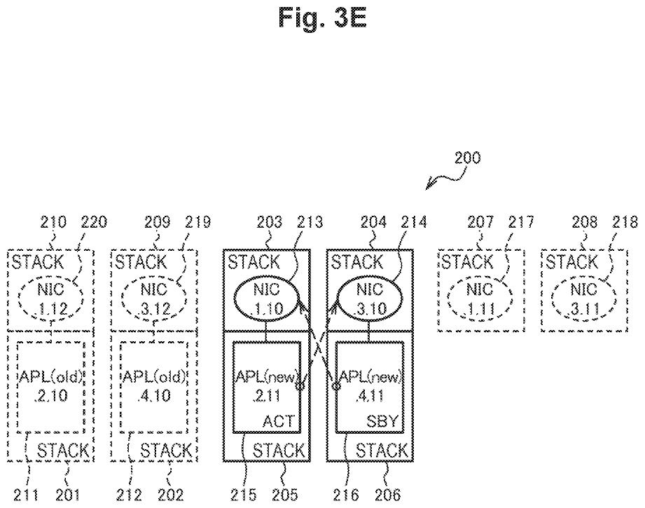

The functions executed by the stack creation unit 110, the stack setting change unit 120, the stack update unit 130, and the normality confirmation unit 140 will be described using the stacks 201 to 210, the virtual machines 211, 212, 215, and 216, and the NICs 213, 214, 217, 218, 219, and 220 described later with reference to FIGS. 3A to 3E.

The stack creation unit 110 performs a process of creating a predetermined stack desired to be created using a template corresponding thereto. Specifically, the following processing is performed.

The stack creation unit 110 creates a stack 205 (fifth stack) and a stack 207 (seventh stack) corresponding to the stack 201 and the stack 203, respectively, by each template. Further, the stack creation unit 110 creates a stack 206 (sixth stack) and a stack 208 (eighth stack) corresponding to the stack 202 and the stack 204, respectively, by each template (see FIG. 3A). Furthermore, the stack creation unit 110 creates, by each template, the stack 209 and the stack 210 corresponding to the stack 203 and the stack 204, respectively, and are temporarily used (see FIG. 3A).

The stack setting change unit 120 performs a process of changing a network interface that is a monitoring target at the current time for a predetermined stack to another network interface. Specifically, the following processing is performed.

The stack setting change unit 120 changes the network interface that is a monitoring target of the stack 206 from the NIC 217 of the stack 207 associated with the stack 205 to the NIC 213 of the stack 203 associated with the stack 201 (see FIG. 3B). Further, the stack setting change unit 120 changes the network interface that is a monitoring target of the stack 205 from the NIC 218 of the stack 208 to the NIC 214 of the stack 204 associated with the stack 206 (FIG. 3D).

The stack update unit 130 executes a process of stopping an instance of the stack and a process of switching the association of the network interface of the stack at the current time to association with another network interface. Specifically, the following processing is performed.

As execution of the update command for the stack 202, the stack update unit 130 stops the instance of the stack 202 (see FIG. 3B). The stack update unit 130 switches the association of the network interface of the stack 202 from the NIC 214 of the stack 204 to the NIC 219 of the temporarily used stack 209 (see FIG. 3B).

Further, as execution of the update command for the stack 206, the stack update unit 130 switches the association of the network interface of the stack 206 from the NIC 218 of the stack 208 to the NIC 214 of the stack 204 (see FIG. 3B). The stack update unit 130 changes the monitoring target of the stack 201 from the stack 202 via the stack 204 to the stack 206 via the stack 204 (see FIG. 3B).

Further, the stack update unit 130 stops (shuts down) the instance of the stack 201 (see FIG. 3C). In this case, the stack update unit 130 causes the stack 206 to transition from the standby state to the active state.

As execution of the update command for the stack 201, the stack update unit 130 causes the stack 201 to stop the process of the application (APL) of the virtual machine 211 (see FIG. 3C). The stack update unit 130 switches the association of the network interface of the stack 201 from the NIC 213 of the stack 203 to the NIC 220 of the temporarily used stack 210 (see FIG. 3D).

Further, as execution of the update command for the stack 205, the stack update unit 130 switches the association of the network interface of the stack 205 from the NIC 217 of the stack 207 to the NIC 213 of the stack 203 (see FIG. 3D).

The normality confirmation unit 140 executes processing of operation confirmation as to whether a stack operates normally after creation of the stack, and operation confirmation such as processing as to whether the stack operates normally when the association of the stack is changed and the stack is restarted. Specifically, the following processing is performed.

The normality confirmation unit 140 starts the created stacks 205 to 208 and checks whether each stack operates normally. The stack 205 and the stack 207 constitute, as an example, a server in an active state, and the stack 206 and the stack 208 constitute a server in a standby state. The stack 205 includes the virtual machine 215, and the virtual machine 215 has an IP address.2.11. Further, the stack 206 includes the virtual machine 216, and the virtual machine 216 has an IP address.4.11.

Further, the normality confirmation unit 140 determines whether or not the stack 206 that monitors the stack 201 normally operates in the active state (first confirmation determination step). In this case, the normality confirmation unit 140 determines a packet output from the NIC 214 of the stack 204 attached to the stack 206, and confirms whether or not the stack 206 is operating normally.

When an abnormality occurs in the stack 206, the normality confirmation unit 140 starts the virtual machine 211 of the stack 201 and switches back. Here, in the present embodiment, switching back means returning the server cluster 200 to the previous state or returning the server cluster 200 to the initial state.

In this case, the normality confirmation unit 140 starts the predetermined application (APL: old) of the virtual machine 211 and the monitoring program, and sets the virtual machine 211 of the stack 201 to the active state on the basis of a determination rule of the monitoring program. That is, the normality confirmation unit 140 can return the server cluster 200 to the state before the occurrence of the abnormality. Further, the normality confirmation unit 140 can not only return to the state before the occurrence of the abnormality by detecting the occurrence of the abnormality, but also return the server cluster 200 to the initial state by tracing back the processing procedure in the reverse order.

Further, the normality confirmation unit 140 determines whether or not the stack 205 is operating normally (second confirmation determination step). In this case, the normality confirmation unit 140 determines a packet output from the NIC 213 of the stack 203 attached to the stack 205, and confirms whether or not the stack 205 is operating normally.

When an abnormality has occurred in the stack 205, the normality confirmation unit 140 stops the instance of the stack 205 and changes the instance of the stack 206 to the active state.

In this case, the normality confirmation unit 140 can return to the state before the abnormality occurs by tracing back the processing procedure in the reverse order. For example, when detecting that an abnormality has occurred in the second confirmation determination step, the normality confirmation unit 140 executes update of the stack 205, and attaches the network interface of the stack 205 back to the NIC 217 of the stack 207 from the NIC 213 of the stack 203. Further, the normality confirmation unit 140 executes update of the stack 201, and attaches the network interface of the stack 201 back to the NIC 213 of the stack 203 from the NIC 220 of the stack 210.

The stack deletion unit 150 executes processing of deleting an unnecessary stack. Specifically, the stack deletion unit 150 deletes an unnecessary stack when the stack 205 is operating normally.

### <Update Control Process>

The update control device 100 of the redundancy system 300 according to the present embodiment creates update stacks 205 and 206 corresponding to the stack 201 and the stack 202, respectively, and sequentially switches the monitoring target among the created stacks 205 and 206, the stack 201, and the stack 202. Thus, the update control device 100 updates each of the predetermined applications (APL: old) installed in the virtual machines 211 and 212 of the stack 201 and the stack 202.

An update control process of the predetermined application (APL: old) installed in the virtual machines 211 and 212 included in the stacks 201 and 202, respectively, accommodated in the server cluster 200 of the redundancy system 300 according to the present embodiment will be described with reference to FIG. 1.

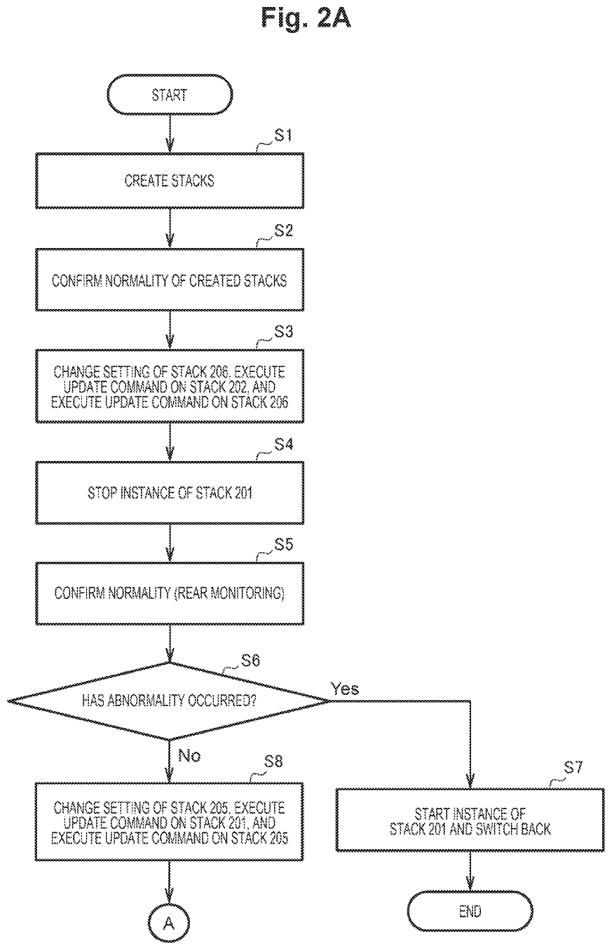

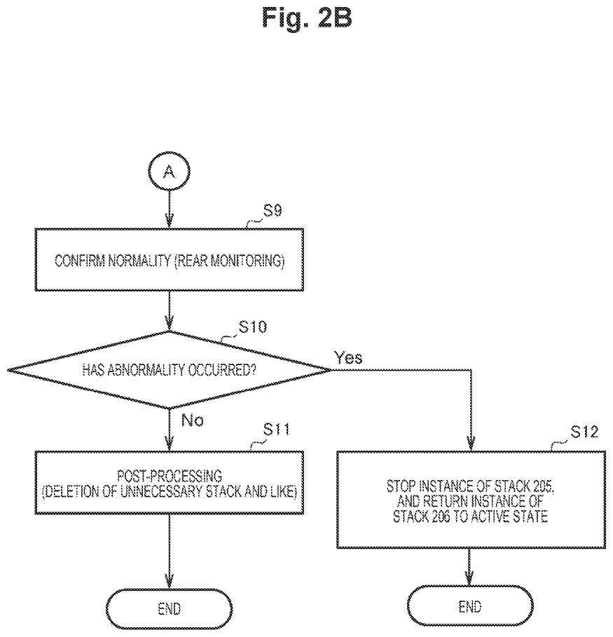

FIGS. 2A and 2B are flowcharts illustrating a flow of the update control process executed by the update control device 100 of the redundancy system 300.

The update control process starts, for example, when the update control device 100 receives an update start instruction for the server cluster 200 from the outside.

First, the stack creation unit 110 of the update control device 100 executes creation of a stack (step S1).

FIG. 3A is a diagram for describing a process in which the stack creation unit 110 creates the stacks 205 to 210 in the server cluster 200.

In step S1, the stack creation unit 110 creates the stack 205 (fifth stack) and the stack 207 (seventh stack) corresponding to the stack 201 and the stack 203, respectively, by each template. Further, the stack creation unit 110 creates the stack 206 (sixth stack) and the stack 208 (eighth stack) corresponding to the stack 202 and the stack 204, respectively, by each template. Furthermore, the stack creation unit 110 creates, by each template, the stack 209 and the stack 210 corresponding to the stack 203 and the stack 204, respectively, and are temporarily used.

Next, the normality confirmation unit 140 of the update control device 100 confirms the normality of the created stacks 205 to 208 (step S2).

The normality confirmation unit 140 starts the created stacks 205 to 208 and checks whether each stack operates normally (normality check). The stack 205 and the stack 207 constitute, as an example, a server in an active state, and the stack 206 and the stack 208 constitute a server in a standby state.

The stack 205 includes the virtual machine 215, and the virtual machine 215 has an IP address.2.11. Further, the stack 206 includes the virtual machine 216, and the virtual machine 216 has an IP address.4.11.

In the virtual machines 215 and 216, a predetermined application (APL: new) obtained by updating the predetermined application (APL: old) is installed, and operation confirmation is performed.

In the stack 205, the NIC 217 of the stack 207 is attached as a secondary network interface for inter-server communication with the stack 206 and the like, and the NIC 217 has an IP address.1.11. In the stack 206, the NIC 218 of the stack 208 is attached as a secondary network interface for inter-server communication with the stack 205 and the like, and the NIC 218 has an IP address.3.11.

The stacks 207 and 208 are configured to be separated as stacks different from the stacks 205 and 206. The stack 205 monitors the stack 206 via the stack 208, and the stack 206 monitors the stack 205 via the stack 207.

Next, the stack setting change unit 120 of the update control device 100 changes the setting of the stack 206, and the stack update unit 130 executes the update command on the stack 202 and the stack 206 (step S3).

FIG. 3B is a diagram for describing a process in which the stack setting change unit 120 changes the setting of the stack 206 and the stack update unit 130 executes the update command on the stack 202 and the stack 206.

As illustrated in FIG. 3B, the stack setting change unit 120 changes the network interface that is a monitoring target of the stack 206 from the NIC 217 of the stack 207 that monitors the stack 205 to the NIC 213 of the stack 203 that monitors the stack 201. Thus, the stack setting change unit 120 changes the monitoring target of the stack 206 from the stack 205 to the stack 201 via the stack 203.

Further, as execution of the update command for the stack 202, the stack update unit 130 stops the instance of the stack 202. The stack update unit 130 switches the association of the network interface of the stack 202 from the NIC 214 of the stack 204 to the NIC 219 of the temporarily used stack 209.

Further, as execution of the update command for the stack 206, the stack update unit 130 switches the association of the network interface of the stack 206 from the NIC 218 of the stack 208 to the NIC 214 of the stack 204. The stack update unit 130 changes the monitoring target of the stack 201 from the stack 202 via the stack 204 to the stack 206 via the stack 204. In this case, by restarting the instance of the stack 206, the stack 206 can recognize the NIC 214 of the stack 204, and the changed configuration becomes effective. Thus, the stack 206 can apply the IP address.3.10 of the NIC 214 of the stack 204.

Next, the stack update unit 130 of the update control device 100 stops the instance of the stack 201 (step S4). The stack 206 monitoring the stack 201 transitions from the standby state to the active state by stopping the instance of the stack 201.

FIG. 3C is a diagram for describing a process in which the stack 206 transitions from the standby state to the active state by stopping the instance of the stack 201.

As illustrated in FIG. 3C, when the stack update unit 130 stops the instance of the stack 201, the stack 206 detects the stop of the stack 201 via the NIC 213 of the stack 203, and transitions from the standby state to the active state.

Here, in the present embodiment, unlike the comparative example, the operation of the stack 206 is confirmed by stopping the virtual machine 211 without deleting the stack 201. Thus, in the present embodiment, the time during which the stack 206 is in a single-system state can be shortened, and the availability can be improved.

Next, the normality confirmation unit 140 of the update control device 100 executes normality confirmation (step S5). In this case, the normality confirmation unit 140 determines a packet output from the NIC 214 of the stack 204 attached to the stack 206, and confirms whether or not the stack 206 is operating normally. That is, the normality confirmation unit 140 determines whether the stack 206 is normal or abnormal by a packet output from the NIC 214 of the stack 204 by the predetermined application (APL: new).

In step S6 (first confirmation determination step), when an abnormality has occurred in the stack 206 (Yes in step S6), the normality confirmation unit 140 starts the instance of the stack 201 and switches back (step S7).

Specifically, the normality confirmation unit 140 returns the server cluster 200 from the state of FIG. 3C to the state of FIG. 3B.

Thus, a predetermined application (APL: old) of the virtual machine 211 and the monitoring program are started, and the virtual machine 211 of the stack 201 enters the active state on the basis of the determination rule of the monitoring program. That is, the normality confirmation unit 140 can return the server cluster 200 to the state before the occurrence of the abnormality.

Further, the normality confirmation unit 140 can not only return to the state before the occurrence of the abnormality by detecting the occurrence of the abnormality, but also return the server cluster 200 to the initial state by tracing back the processing procedure in the reverse order.

On the other hand, when no abnormality has occurred in the stack 206 (first confirmation determination step) (No in step S6), the normality confirmation unit 140 determines that the stack 206 is operating normally, the stack setting change unit 120 changes the setting of the stack 205, and the stack update unit 130 executes the update command on the stacks 201 and 205 (step S8).

FIG. 3D is a diagram for describing a process in which the stack setting change unit 120 changes the setting of the stack 205 and the stack update unit 130 executes the update command on the stack 201 and the stack 205.

As illustrated in FIG. 3D, the stack setting change unit 120 changes the network interface that is a monitoring target of the stack 205 from the NIC 218 of the stack 208 to the NIC 214 of the stack 204 that monitors the stack 206. Thus, the stack setting change unit 120 can change the monitoring target of the stack 205 to the stack 206 via the stack 204.

Further, as execution of the update command for the stack 201, the stack update unit 130 causes the stack 201 to stop the process of the predetermined application (APL: old) of the virtual machine 211. The stack update unit 130 switches the association of the network interface of the stack 201 from the NIC 213 of the stack 203 to the NIC 220 of the temporarily used stack 210.

Further, as execution of the update command for the stack 205, the stack update unit 130 switches the association of the network interface of the stack 205 from the NIC 217 of the stack 207 to the NIC 213 of the stack 203. In this case, by restarting the instance of the stack 205, the stack 205 can recognize the NIC 213 of the stack 203, and the changed configuration becomes effective. That is, the stack 205 can apply the IP address.1.10 of the NIC 213 of the stack 203.

Thus, the stack 205 monitors the stack 206 via the stack 204, and the stack 206 monitors the stack 205 via the stack 203.

Therefore, each monitoring program of the virtual machine 215 of the stack 205 and each monitoring program of the virtual machine 216 of the stack 206 monitor each other. Here, in a case where the virtual machine 215 and the virtual machine 216 are in the active state with respect to each other, for example, the virtual machine 215 of the stack 205 is set to be prioritized. Thus, the virtual machine 216 of the stack 206 transitions from the active state to the standby state.

Next, the normality confirmation unit 140 of the update control device 100 executes normality confirmation (step S9 in FIG. 2B). In this case, the normality confirmation unit 140 determines a packet output from the NIC 213 of the stack 203 attached to the stack 205, and confirms whether or not the stack 205 is operating normally. That is, the normality confirmation unit 140 determines whether the stack 205 is normal or abnormal by a packet output from the NIC 213 of the stack 203 by the predetermined application (APL: new).

In step S10 (second confirmation determination step), when no abnormality has occurred in the stack 205 (No in step S10), the normality confirmation unit 140 determines that the stack 205 is operating normally, and the stack deletion unit 150 deletes an unnecessary stack (step S11) and ends the update control process.

FIG. 3E is a diagram for describing a process of deleting an unnecessary stack by the stack deletion unit 150 in step S11.

As illustrated in FIG. 3E, the stack deletion unit 150 deletes the stacks 201, 202, and 207 to 210. In the redundancy system 300, since update of the predetermined application (APL: new) of the virtual machines 215 and 216 is completed by the stacks 205 and 206, the stack deletion unit 150 deletes the stacks 201, 202, and 207 to 210 that are no longer necessary.

On the other hand, in a case where an abnormality has occurred in the stack 205 in step S10 (second confirmation determination step) (Yes in step S10), the normality confirmation unit 140 stops the instance of the stack 205 and returns the instance of the stack 206 to the active state (step S12), and ends the update control process.

Specifically, the normality confirmation unit 140 returns the server cluster 200 from the state of FIG. 3D to the state of FIG. 3C, and ends the update control process.

Thus, the normality confirmation unit 140 can cancel (avoid) the stop state of the service of the server cluster 200.

In this case, the normality confirmation unit 140 can return to the state before the abnormality occurs by tracing back the processing procedure in the reverse order. For example, when detecting that an abnormality has occurred in the second confirmation determination step, the normality confirmation unit 140 executes update of the stack 205, and attaches the network interface of the stack 205 back to the NIC 217 of the stack 207 from the NIC 213 of the stack 203. Further, the normality confirmation unit 140 executes update of the stack 201, and attaches the network interface of the stack 201 back to the NIC 213 of the stack 203 from the NIC 220 of the stack 210.

Thus, the normality confirmation unit 140 can return the server cluster 200 to the state before the occurrence of the abnormality. In addition, since the redundancy system 300 has not deleted any of the stacks 201 to 210, the server cluster 200 can be returned to the initial state by further tracing back the processing procedure in the reverse order.

As described above, unlike the comparative example, the redundancy system 300 does not delete the stack until the update is completed, and thus even if an unexpected problem occurs, it is possible to return the server cluster 200 to the initial state by tracing back the processing procedure in the reverse order.

### <Hardware Configuration of Update Control Device>

The update control device 100 according to the present embodiment is implemented by, for example, a computer 900 having a configuration as illustrated in FIG. 4.

FIG. 4 is a hardware configuration diagram illustrating an example of the computer 900 that implements the functions of the update control device 100. The computer 900 includes a central processing unit (CPU) 901, a read only memory (ROM) 902, a RAM 903, a hard disk drive (HDD) 904, an input/output interface (I/F) 905, a communication I/F 906, and a media I/F 907.

The CPU 901 operates on the basis of a program (update control program) stored in the ROM 902 or the HDD 904 to embody the stack creation unit 110, the stack setting change unit 120, the stack update unit 130, the normality confirmation unit 140, and the stack deletion unit 150. The ROM 902 stores a boot program to be executed by the CPU 901 when the computer 900 is started, a program related to hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that a graphics processing unit (GPU) or the like may be used as a processor together with the CPU 901.

The HDD 904 stores a program to be executed by the CPU 901, data to be used by the program, and the like. The communication I/F 906 receives data from another device via a communication network (for example, network (NW) 920), outputs the data to the CPU 901, and transmits data generated by the CPU 901 to another device via the communication network.

The media I/F 907 reads a program (update control program) or data stored in a recording medium 912, and outputs the read program or data to the CPU 901 via the RAM 903. The CPU 901 loads a program related to a target process from the recording medium 912 onto the RAM 903 via the media I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, in a case where the computer 900 functions as the update control device 100 of the present invention, the CPU 901 of the computer 900 implements each function of the update control device 100 by executing a program loaded on the RAM 903. Further, the HDD 904 stores data in the RAM 903. The CPU 901 reads the program related to the target processing from the recording medium 912, and executes the program. Additionally, the CPU 901 may read the program related to the target processing from another device via the communication network (NW 920).

### <Effects>

Hereinafter, effects of the update control method and the like of the redundancy system 300 according to the present invention will be described.

An update control method of a redundancy system 300 according to the present invention is an update control method of a redundancy system 300 including a stack 201 (first stack) indicating an instance group of a virtual resource, a stack 202 (second stack) indicating an instance group of a virtual resource, and an update control device 100 that controls update of an application stored in each of virtual resources of the stack 201 and the stack 202, in which the stack 201 constitutes a virtual machine 211 (virtual server) in association with a stack 203 (third stack) indicating a secondary interface for communication with another stack other than the stack 201, and the stack 202 constitutes a virtual machine 212 (virtual server) in association with a stack 204 (fourth stack) indicating the secondary interface, the virtual machines 211 and 212 are redundant in an active state or a standby state, and the update control device 100 executes a creation step of generating a virtual machine 215 (virtual server) corresponding to the stack 201 and including a stack 205 (fifth stack) in which a new application indicating the application that is updated is stored and a virtual machine 216 (virtual server) corresponding to the stack 202 and including a stack 206 (sixth stack) in which the new application is stored, and a changing step of sequentially performing a process of changing a stack indicating the secondary interface associated with the stack 205 to the stack 203 and a process of changing a stack indicating the secondary interface associated with the stack 206 to the stack 204.

As described above, by the update control method of the redundancy system 300 according to the present invention, the time during which the stacks 205 and 206 are in a single-system state can be shortened by the created stacks 201 and 202, and the availability can be improved. Further, since the update control method of the redundancy system 300 does not delete any stack, the server cluster 200 can be switched back even if an unexpected problem occurs. That is, the update control method of the redundancy system 300 can return the server cluster 200 to the initial state.

Further, in the update control method of the redundancy system 300 according to the present invention, the changing step includes a step of changing a monitoring target of the stack 206 from the stack 205 to the stack 201 via the stack 203, and a step of stopping an instance of the stack 202 and changing a monitoring target of the stack 201 from the stack 202 via the stack 204 to the stack 206 via the stack 204.

As described above, by to the update control method of the redundancy system 300 according to the present invention, the operation is monitored by the stack 201 and the stack 206. Therefore, the update control method of the redundancy system 300 can shorten the time to be in the single-system state and improve the availability.

Further, in the update control method of the redundancy system 300 according to the present invention includes, the changing step stops an instance of the stack 201, and includes a step of changing a network interface of the stack 205 to the stack 203 and monitoring the stack 206 by the stack 205 via the stack 204 when the stack 206 that monitors the stack 201 is operating normally in an active state, and a step of monitoring the stack 205 by the stack 206 via the stack 203 and changing the stack 206 to a standby state when the stack 205 is in an active state.

As described above, by the update control method of the redundancy system 300 according to the present invention, since the stack 206 and the stack 205 mutually monitor the operation after it is determined whether or not the stack 206 is operating normally, it is possible to shorten the time to be in the single-system state and to improve the availability.

Further, in the update control method of the redundancy system 300 according to the present invention, the changing step stops an instance of the stack 201, and starts an instance of the stack 201 when the stack 206 that monitors the stack 201 is not operating normally in an active state.

As described above, by the update control method of the redundancy system 300 according to the present invention, when the stack 206 is not operating normally in the active state in the middle of update, it is possible to return to the previous state. That is, in the update control method of the redundancy system 300, a procedure of processing can be traced back in the reverse order, and the state can be returned to the normal operation state. Furthermore, the update control method of the redundancy system 300 can return the server cluster 200 to the initial state by tracing back the procedure of processing in the reverse order.

Further, in the update control method of the redundancy system 300 according to the present invention, the changing step deletes an unnecessary stack when the stack 205 is operating normally.

As described above, by the update control method of the redundancy system 300 according to the present invention, it is possible to delete an unnecessary stack after confirming that the update process is completed.

Further, in the update control method of the redundancy system 300 according to the present invention, the changing step stops an instance of the stack 205 and changes an instance of the stack 206 to an active state when the stack 205 is not operating normally.

As described above, in the update control method of the redundancy system 300 according to the present invention, when the stack 205 is not operating normally in the middle of the update process, it is possible to return to a previous state of operating normally. Furthermore, the update control method of the redundancy system 300 can return to the initial state of the server cluster 200 by tracing back the procedure of processing in the reverse order.

Note that the present invention is not limited to the above-described embodiment, and many modifications can be made by those skilled in the art within the technical idea of the present invention.

### REFERENCE SIGNS LIST

100 Update control device
110 Stack creation unit (creation unit)
120 Stack setting change unit (change unit)
130 Stack update unit (update unit)
140 Normality confirmation unit
150 Stack deletion unit
200 Server cluster
201 to 210 Stack
211, 212, 215, 216 Virtual machine
203, 204, 207, 208, 209, 210 NIC
300 Redundancy system

1. An update control method of a redundancy system including a first stack indicating an instance group of a virtual resource, a second stack indicating an instance group of a virtual resource, and an update control device that controls update of an application stored in each of virtual resources of the first stack and the second stack, wherein
the first stack constitutes a virtual server in association with a third stack indicating a secondary interface for communication with another stack other than the first stack, and the second stack constitutes a virtual server in association with a fourth stack indicating the secondary interface,
the virtual servers are redundant in an active state or a standby state, and
the update control device executes
a creation step of generating a virtual server corresponding to the first stack and including a fifth stack in which a new application indicating the application that is updated is stored and a virtual server corresponding to the second stack and including a sixth stack in which the new application is stored, and
a changing step of sequentially performing a process of changing a stack indicating the secondary interface associated with the fifth stack to the third stack and a process of changing a stack indicating the secondary interface associated with the sixth stack to the fourth stack.

2. The update method of the redundancy system according to claim 1, wherein
the changing step includes
a step of changing a monitoring target of the sixth stack from the fifth stack to the first stack via the third stack, and
a step of stopping an instance of the second stack and changing a monitoring target of the first stack from the second stack via the fourth stack to the sixth stack via the fourth stack.

3. The update method of the redundancy system according to claim 2, wherein
the changing step
stops an instance of the first stack, and includes
a step of changing a network interface of the fifth stack to the third stack and monitoring the sixth stack by the fifth stack via the fourth stack when the sixth stack that monitors the first stack is operating normally in an active state, and
a step of monitoring the fifth stack by the sixth stack via the third stack and changing the sixth stack to a standby state when the fifth stack is in an active state.

4. The update method of the redundancy system according to claim 2, wherein
the changing step
stops an instance of the first stack, and
starts an instance of the first stack when the sixth stack that monitors the first stack is not operating normally in an active state.

5. The update method of the redundancy system according to claim 3, wherein
the changing step
deletes an unnecessary stack when the fifth stack is operating normally.

6. The update method of the redundancy system according to claim 3, wherein
the changing step
stops an instance of the fifth stack and changes an instance of the sixth stack to an active state when the fifth stack is not operating normally.

7. A redundancy system comprising a first stack indicating an instance group of a virtual resource, a second stack indicating an instance group of a virtual resource, and an update control device that controls update of an application stored in each of virtual resources of the first stack and the second stack, wherein
the first stack constitutes a virtual server in association with a third stack indicating a secondary interface for communication with another stack other than the first stack, and the second stack constitutes a virtual server in association with a fourth stack indicating the secondary interface,
the virtual servers are redundant in an active state or a standby state, and
the update control device includes
a creation unit including one or more processors, configured to generate a virtual server corresponding to the first stack and including a fifth stack in which a new application indicating the application that is updated is stored and a virtual server corresponding to the second stack and including a sixth stack in which the new application is stored, and
a changing unit including one or more processors, configured to sequentially perform a process of changing a stack indicating the secondary interface associated with the fifth stack to the third stack and a process of changing a stack indicating the secondary interface associated with the sixth stack to the fourth stack.

8. An update control device for controlling update of an application stored in each of virtual resources of a first stack indicating an instance group of a virtual resource and a second stack indicating an instance group of a virtual resource, wherein
the first stack constitutes a virtual server in association with a third stack indicating a secondary interface for communication with another stack other than the first stack, and the second stack constitutes a virtual server in association with a fourth stack indicating the secondary interface,
the virtual servers are redundant in an active state or a standby state, and
the update control device comprises
a creation unit including one or more processors, configured to generate a virtual server corresponding to the first stack and including a fifth stack in which a new application indicating the application that is updated is stored and a virtual server corresponding to the second stack and including a sixth stack in which the new application is stored, and
a changing unit including one or more processors, configured to sequentially perform a process of changing a stack indicating the secondary interface associated with the fifth stack to the third stack and a process of changing a stack indicating the secondary interface associated with the sixth stack to the fourth stack.

9. The redundancy system according to claim 7, wherein
the changing unit is configured to:
change a monitoring target of the sixth stack from the fifth stack to the first stack via the third stack, and
stop an instance of the second stack and changing a monitoring target of the first stack from the second stack via the fourth stack to the sixth stack via the fourth stack.

10. The redundancy system according to claim 9, wherein
the changing unit is configured to:
stop an instance of the first stack,
change a network interface of the fifth stack to the third stack and monitoring the sixth stack by the fifth stack via the fourth stack when the sixth stack that monitors the first stack is operating normally in an active state, and
monitor the fifth stack by the sixth stack via the third stack and changing the sixth stack to a standby state when the fifth stack is in an active state.

11. The redundancy system according to claim 9, wherein
the changing unit is configured to:
stop an instance of the first stack, and
star an instance of the first stack when the sixth stack that monitors the first stack is not operating normally in an active state.

12. The redundancy system according to claim 10, wherein
the changing unit is configured to:
delete an unnecessary stack when the fifth stack is operating normally.

13. The redundancy system according to claim 10, wherein
the changing unit is configured to:
stop an instance of the fifth stack and change an instance of the sixth stack to an active state when the fifth stack is not operating normally.

14. The update control device according to claim 8, wherein
the changing unit is configured to:
change a monitoring target of the sixth stack from the fifth stack to the first stack via the third stack, and
stop an instance of the second stack and changing a monitoring target of the first stack from the second stack via the fourth stack to the sixth stack via the fourth stack.

15. The update control device according to claim 14, wherein
the changing unit is configured to:
stop an instance of the first stack,
change a network interface of the fifth stack to the third stack and monitoring the sixth stack by the fifth stack via the fourth stack when the sixth stack that monitors the first stack is operating normally in an active state, and
monitor the fifth stack by the sixth stack via the third stack and changing the sixth stack to a standby state when the fifth stack is in an active state.

16. The update control device according to claim 14, wherein
the changing unit is configured to:
stop an instance of the first stack, and
star an instance of the first stack when the sixth stack that monitors the first stack is not operating normally in an active state.

17. The update control device according to claim 15, wherein
the changing unit is configured to:
delete an unnecessary stack when the fifth stack is operating normally.

18. The update control device according to claim 15, wherein
the changing unit is configured to:
stop an instance of the fifth stack and change an instance of the sixth stack to an active state when the fifth stack is not operating normally.
